(19) United States
(12) Patent Application Publication
(10) Pub. No.: US 2014/0076210 A1
(43) Pub. Date: Mar. 20, 2014

(54) BIOMASS MILL AND BIOMASS-COAL MIXED COMBUSTION SYSTEM

(71) Applicant: MITSUBISHI HEAVY INDUSTRIES, LTD, Minato-ku, Tokyo (JP)

(72) Inventors: Takuichiro Daimaru, Tokyo (JP); Tsugio Yamamoto, Tokyo (JP); Kenichi Arima, Tokyo (JP); Masaaki Kinoshita, Tokyo (JP); Kazuhiro Tekeuchi, Tokyo (JP); Norichika Kai, Nagasaki (JP); Yoshishige Uematsu, Nagasaki (JP)

(21) Appl. No.: 14/122,447

(22) PCT Filed: Sep. 30, 2011
(86) PCT No.: PCT/JP2011/072537

§ 371 Date: Nov. 26, 2013

(51) Int. Cl. B02C 15/00; B02C 23/26; B02C 15/04; F23K 3/00; F23G 5/033

(52) U.S. Cl. CPC B02C 15/001; F23K 3/00; F23G 5/033; B02C 15/045; B02C 23/26
USPC 110/222; 241/49; 241/119

(57) ABSTRACT

The present invention includes: a mill main body with a material feed pipe for feeding a biomass material from above in a vertical axis direction; a mill table on which the fed biomass material is placed; a drive unit rotating and driving the mill table; a mill roller that operates in conjunction with rotation of the mill table to mill the biomass material by a pressing force; and a ventilation means that forms an upward flow to blow out a carrier gas to convey milled biomass powder, wherein the mill main body has a barrel part decreased in diameter in the middle thereof in the vertical axis direction, and the mill main body has on a top plate thereof a plurality of discharge tubes circumferentially arranged for discharging the biomass powder on a line extended from the diameter-decreased barrel part in the vertical axis direction.

### FIELD

The present invention relates to biomass mills milling biomass solids to fine powder, and biomass-coal mixed combustion systems.

### BACKGROUND

In recent years, CO₂ emission reduction has been propelled from the viewpoint of prevention of global warming. In particular, fossil fuels such as coal and heavy oil are frequently used at combustion equipment such as electric-power generating boilers, which is a factor responsible for global warming due to CO₂ emission, and thus the use of fossil fuels has been being restricted in terms of global environment protection. In addition, there also has been demand for development and practical realization of alternative energy resources from the viewpoint of taking measures on depletion of fossil fuels. Thus, as an alternative to fossil fuels, the utilization of biomass fuels has been promoted. Biomass refers to organic matter resulting from photosynthesis, and includes woody biomass, herbaceous biomass, crop biomass, garbage biomass, and others. By processing biomass into fuel, the biomass can be effectively used as an energy source or an industrial raw material.

Biomass has been brought into use as fuel from the viewpoint of high-efficient utilization of biomass as a renewable energy. As a way of using biomass as fuel, biomass solids are milled into fine powder and supplied as fuel to a pulverized coal boiler. To mill biomass solids, there are two known methods: single milling by which coal and biomass are separately milled; and mixture milling by which coal and biomass are mixed before being milled. In either method, a biomass mill is needed to mill biomass solids. However, when an existing mill in a conventional coal boiler is used, the mixed combustion ratio of the two materials is only about 10 cal % at a maximum due to constraints to capability of the existing mill.

Conventionally, a coal mill is used to mill and reduce biomass into a particle size suited for a coil boiler. For example, a biomass material is put onto a mill table in the mill, and milled by a mill roller rotating in conjunction with the mill table, and dried and classified. Then, the milled biomass is conveyed by an air flow to the burner (see Patent Literature 1 and Patent Literature 2).

In this case, coal is milled by a vertical roller mill. However, biomass solids are stretchable and less prone to be milled as compared to coal, and thus it is difficult to mill and reduce biomass solids into a predetermined size by the vertical roller mill for coal. Therefore, biomass solids are conventionally milled by mill machines such as hummer mills or cutter mills. However, milling biomass solids by a hummer mill or a cutter mill requires a large amount of power, which brings about a decrease in milling efficiency. In addition, the foregoing method shortens the life of the mill and requires maintenance of the mill at shorter intervals, which makes it difficult to run the mill continuously.

The patent literatures shown below and the like suggest biomass mills using vertical mills. For example, the biomass mill disclosed in Patent Literature 2 is configured to press and mill biomass solids on a rotated and driven mill table by a roller operating in conjunction with rotation of the table, convey the milled biomass upward by a flow of air blowing from the lower side, and classify the milled biomass into coarse powder and fine powder. The biomass mill disclosed in Patent Literature 3 is configured to control the pressing force of a roller and the rotation speed of a table so as to fall within specific ranges to facilitate mutual grinding of biomass chips according to the distance between the roller and the table.

### CITATION LIST

### Patent Literatures

Patent Literature 1: Japanese Laid-open Patent Publication No. 2004-347241

Patent Literature 2: Japanese Laid-open Patent Publication No. 2009-291692

Patent Literature 3: Japanese Laid-open Patent Publication No. 2008-043926

### SUMMARY

### Technical Problem

However, when a woody biomass material is to be milled by a conventional coal mill, the following problem arises.

1) The biomass material has a lower specific gravity than coal and varies in milled shape, and thus the product particle size is mainly controlled by air volume adjustment. In that case, the biomass powder is not be sufficiently classified by a mechanical classifier such as a rotary classifier, for example.

In addition, the biomass material is high in fiber and flexible. The biomass material is a low grindability fuel compared to coal and thus is decreased in volume when being milled. Accordingly, when the biomass material is to be milled by a vertical roller mill for coal, the A (air)/C (coal) ratio is 7 or more (actually 7 to 13), and it is thus necessary to provide a bin system such as a bug filter or a cyclone, for example, to separate the powder from the air at a stage prior to supply to boiler equipment. As a result, the bin system may cause trouble such as clogging, firing, or the like, for example.

Therefore, there has been the need for advent of a biomass mill that allows milled biomass powder to be efficiently discharged to the outside, without using conventional coal mills simply diverted to biomass milling.

In light of the foregoing problem, a first issue of the present invention is to provide a biomass mill and a biomass-coal mixed combustion system that allow milled biomass powder to be efficiently discharged to the outside.

In addition to the problem 1), when a woody biomass material is to be milled by a conventional coal mill, the following problems arise.

2) The woody biomass material is compressible unlike coal, and thus when the biomass material is to be ground and milled between a mill roller and a mill table, sufficient pressure is not transferred to the biomass material and thus the biomass material is hard to mill.

In addition, the biomass material has a high water content and is rich in fiber, and thus when the biomass material is sandwiched and crushed between a mill roller and a mill table, the milled biomass particles (fine powder) become entangled with each other and are hard to separate.

Therefore, when the biomass material is milled by a conventional coal mill, coarse particles and fine powder of the milled biomass come together and become less prone to move. As a result, the biomass material is over-milled. This brings about a significant decrease in a milled amount of the biomass material and an increase in power consumption of the mill, as compared to the case of milling coal.

Further, in the case where a biomass material and coal are mixed and milled, when the mixed milling ratio of the woody biomass material, which is in general 5 to 10%, is increased to the limit of mixing the woody biomass material, the particle size of fine powder decreases and combustion efficiency in the burner deteriorates.

In addition, since power of the mill is increased in the foregoing case, it is necessary to operate the mill with a reduced capacity.

3) To subject a woody biomass material to suspension burning in a conventional coal boiler, it is necessary to mill and reduce the biomass material into an average particle size of about 0.5 to 1 mm. However, it is less efficient to mill and reduce a large volume of biomass material into this size by a hummer mill or a cutter mill, for example.

4) The woody biomass powder (coarse particles) not sufficiently milled have irregular shapes and are prone to be entangled with each other. Accordingly, when the biomass powder is discharged from an outer peripheral part of the mill roller and raised by an injected air current around the mill table, it is not easy to separate coarse particles and fine powder, which brings about an increase in the ratio of the biomass powder over-milled beyond the particle size necessary for burnout and an increase in milling power.

Therefore, there has been the need for advent of a biomass mill that is capable of milling a woody biomass material in an efficient and stable manner, without using conventional coal mills simply diverted to biomass milling.

In light of the foregoing problems, a second issue of the present invention is to provide a biomass mill and a biomass-coal mixed combustion system that are capable of milling a biomass material in an efficient manner.

Further, a biomass solid is high in fiber and flexible, and it is difficult to mill the biomass solid efficiently only by a compressing force of the roller. This requires a large amount of power and time with a decrease in milling efficiency.

The present invention is devised to solve the foregoing problem, and a third issue of the present invention is to provide a vertical mill that is capable of milling a solid such as biomass with efficiency and improving milling efficiency.

### Solution to Problem

According to a first aspect of the present invention in order to solve the above problems, there is provided a biomass mill including: a mill main body including a material feed pipe for feeding a biomass material from above in a vertical axis direction; a mill table for placing the fed biomass material; a drive unit for rotating and driving the mill table; a mill roller for operating in conjunction with rotation of the mill table so as to mill the biomass material by a pressing force; and a ventilation means for forming an upward flow from below on the outer peripheral side of the mill table and blowing out a carrier gas so as to convey milled biomass powder by a flow of air, wherein the mill main body has a barrel part decreased in diameter in the middle thereof in the vertical axis direction, and the mill main body has on a top part thereof a plurality of discharge tubes circumferentially arranged for discharging the biomass powder on a line extended from the diameter-decreased barrel part in the vertical axis direction.

According to a second aspect of the present invention, there is provided the biomass mill according to the first aspect, wherein collision plates are provided near openings of the discharge tubes.

According to a third aspect of the present invention, there is provided the biomass mill according to the first or second aspect, wherein the diameter-decreased barrel part 21 is extended by a predetermined length in the vertical axis direction.

According to a fourth aspect of the present invention, there is provided the biomass mill according to the first or second aspect, wherein the barrel part of the mill main body is variable on the top part side.

According to a fifth aspect of the present invention, there is provided a biomass mill, including: a mill main body having a material feed pipe for feeding a biomass material from above in a vertical axis direction; a mill table having a table liner for placing the fed biomass material; a drive unit for rotating and driving the mill table; a mill roller for operating in conjunction with rotation of the mill table so as to mill the biomass material by a pressing force; a ventilation means for forming an upward flow from below on the outer peripheral side of the mill table and blowing out a carrier gas so as to convey milled biomass powder by a flow of air; and a classifier provided on the top part side of the mill main body, for classifying biomass fine particles entrained in the carrier gas, wherein the table liner of the mill table is divided into a plurality of fan-like segments, and the fan-like segments are different in thickness in the height direction.

According to a sixth aspect of the present invention, there is provided the biomass mill according to the fifth aspect, wherein the fan-like segments have the identical shape.

According to a seventh aspect of the present invention, there is provided a biomass mill, including: a mill table rotatably supported in a mill main body, including a rotation axis center along a vertical direction of the mill main body; a mill roller arranged above the mill table, the mill roller being opposed to the mill table and rotatably supported; and a roller speed adjustment mechanism for adjusting a rotation speed of the mill roller such that the peripheral speed of the mill roller is different from the peripheral speed of the mill table.

According to an eighth aspect of the present invention, there is provided the biomass mill according to the seventh aspect, wherein the roller speed adjustment mechanism includes a brake/drive device for applying a drive force or a brake force to the mill roller.

According to a ninth aspect of the present invention, there is provided the biomass mill according to the seventh or eighth aspect, wherein the roller speed adjustment mechanism includes a drive device for applying a drive force to the mill roller, and the drive device is configured to adjust the rotation speed of the mill roller such that the peripheral speed of the mill roller is higher than the peripheral speed of the mill table.

According to a tenth aspect of the present invention, there is provided the biomass mill according to the seventh or eighth aspect, wherein the roller speed adjustment mechanism includes an electric motor for driving and rotating the mill roller.

According to an eleventh aspect of the present invention, there is provided the biomass mill according to the tenth aspect, wherein the electric motor is configured to regenerative-brake.

According to a twelfth aspect of the present invention, there is provided a biomass-coal mixed combustion system, including: the biomass mill according to any one of the first, fifth, and seventh aspects; a coal mill for milling a coal material; and a boiler furnace into which biomass powder milled by the biomass mill and coal powder milled by the coal mill are fed.

### Advantageous Effects of Invention

According to the present invention, when the barrel part of the central part is reduced in diameter, it is possible to satisfy the internal superficial velocity necessary for conveyance of the biomass powder even if the flow volume of carrier gas is set equivalent to a desired volume (A/C=2 to 5).

According to the present invention, when the segments are different in height and alternately arranged to form a stepped plane in the circumferential direction, it is possible to allow the mill to cut biomass fibers at the angular parts of the convex segments and mill the biomass material in an efficient manner.

According to the present invention, when the mill roller is disposed above the mill table so as to be opposed to the mill table and the mill roller is capable of being adjusted by the roller speed adjustment mechanism such that the peripheral speed of the mill roller is different from the peripheral speed of the mill table, it is possible to allow the mill to mill a solid matter such as biomass in an efficient manner and improve in milling efficiency.

### BRIEF DESCRIPTION OF DRAWINGS

FIG. 1 is a schematic view of a biomass mill according to a first embodiment.

FIG. 2 is a schematic cross section view of the biomass mill according to the first embodiment.

FIG. 3 is a schematic view of a biomass mill according to a second embodiment.

FIG. 4 is a schematic view of a biomass mill according to a third embodiment.

FIG. 5 is a schematic view of a biomass mill according to a fourth embodiment.

FIG. 6 is a schematic view of a biomass-coal mixed combustion system with a boiler furnace according to a fifth embodiment.

FIG. 7 is a schematic view of a biomass mill according to a sixth embodiment.

FIG. 8 is a schematic cross section view of the biomass mill according to the sixth embodiment.

FIG. 9 is a schematic view of a table liner and a mill roller according to the sixth embodiment.

FIG. 10 is a plane view of the table liner according to the sixth embodiment.

FIG. 11 is a front view of a mill roller and a drive unit for the same in a vertical mill according to a seventh embodiment.

FIG. 12 is a schematic configuration diagram of the vertical mill according to the seventh embodiment.

FIG. 13 is a front view of a mill roller and a drive unit for the same in a vertical mill according to an eighth embodiment.

### DESCRIPTION OF EMBODIMENTS

The present invention will be described below in detail with reference to the drawings. However, the present invention is not limited by the following embodiments, but when there is a plurality of embodiments, the present invention includes combinations of these embodiments. In addition, constitutional elements in the following embodiments include elements that readily could have been conceived of by a person skilled in the art and elements that are virtually identical.

### First Embodiment

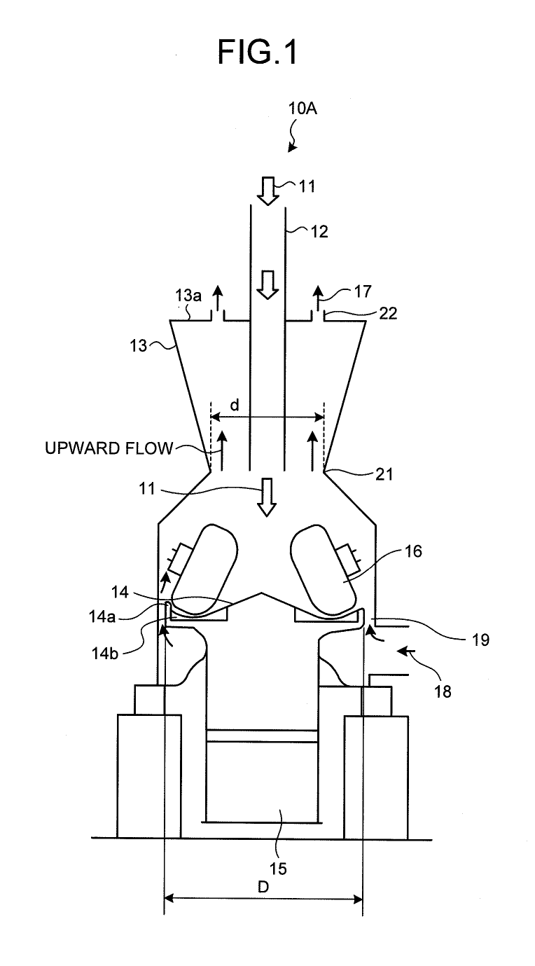

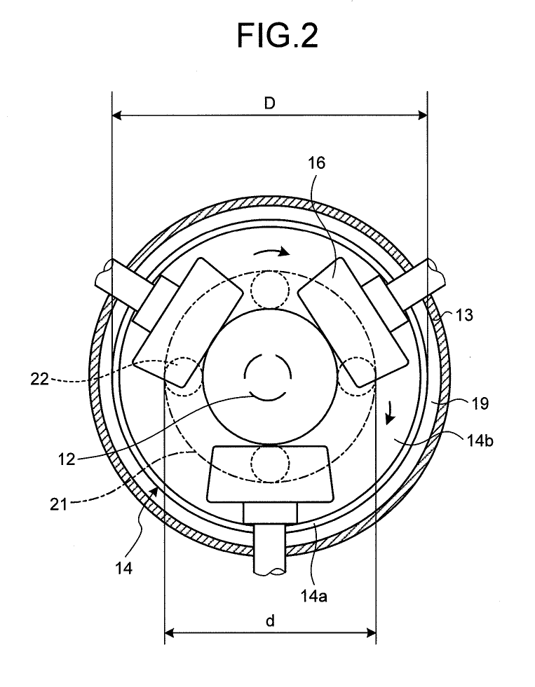

A biomass mill according to a first embodiment in the present invention will be described with reference to the drawings. FIG. 1 is a schematic view of the biomass mill according to the embodiment. FIG. 2 is a schematic cross section view of the biomass mill according to the first embodiment.

As illustrated in FIGS. 1 and 2, a biomass mill 10A according to the embodiment includes: a mill main body 13 having a material feed pipe 12 for feeding a biomass material 11 from above in the vertical axis direction; a mill table 14 on which the fed biomass material 11 is placed; a drive unit 15 rotating and driving the mill table 14; a mill roller 16 that operates in conjunction with rotation of the mill table 14 to mill the biomass material 11 by a pressing force; and a ventilation means (not illustrated) that forms an upward flow from below on the outer peripheral side of the mill table 14 to blow out a carrier gas 18 to convey milled biomass powder 17 by a flow of air, wherein the mill main body 13 has a barrel part 21 decreased in diameter in the middle thereof in the vertical axis direction, and the mill main body 13 has a plurality of discharge tubes 22 circumferentially arranged for discharging the biomass powder 17 on a top plate 13a on a line extended from the diameter-decreased barrel part 21 in the vertical axis direction.

The mill table 14 is formed into an almost circular stand. The mill table 14 has an upper surface that is concaved to prevent the biomass solid placed on the table from dropping out and is provided with a barrier 14a on the outer peripheral side thereof. In addition, the mill table 14 has a replaceable table liner 14b to prevent abrasion of the mill table 14.

The mill table 14 has a drive shaft (not illustrated) extended from under the table and connected to a motor (not illustrated) such that the mill table 14 is rotated and driven by the motor.

The mill roller 16 is provided above the mill table 14 at a position shifted outward from the center of the mill table 14. The mill roller 16 rotates in conjunction with rotation of the mill table 14 and exerts a pressing force on the biomass material 11 placed on the table liner 14b of the mill table 14 to mill the biomass material 11.

In this arrangement, the motor is connected to a decelerator, and the mill roller 16 is connected to a variable oil pressure source or a spring for changing a milling load. The motor and the mill roller 16 are configured to be capable of being controlled by a control device (not illustrated) to increase and decrease a milling load of the mill roller 16 in a step-less or stepwise manner to keep a milling power within a rated range or preferably in an almost constant state.

The material feed pipe 12 is inserted through the top plate 13a into the mill main body 13 in the vertical axis direction and is disposed to drop the biomass material 11 onto the mill table 14.

The ventilation means for supplying the carrier gas (primary air) 18 is configured to supply a predetermined flow volume of the primary air at a predetermined temperature into the mill main body 13 from the periphery of the mill table 14. The ventilation means uses a damper or the like to adjust a flow volume of air. In addition, the ventilation means includes a temperature adjustment means as necessary. The flow volume and the temperature of air are appropriately controlled by a control device not illustrated.

A gap 19 is provided between the outer peripheral edge of the mill table 14 and the inner peripheral surface of the mill main body 13 such that the carrier gas (primary air) 18 supplied from the ventilation means blows through the gap 19 above the mill table 14. The gap 19 may be provided with a drift vane (not illustrated). The drift vane is intended to adjust the direction of blowing of the primary air, and more preferably, the drift vane may be arbitrarily controlled in angle.

In the embodiment, the mill main body 13 has the barrel part 21 in the middle thereof decreased in diameter in the vertical axis direction, and the mill main body 13 has the plurality of discharge tubes 22 circumferentially arranged for discharging the biomass powder (fine powder) 17 on the top plate 13a on a line extended from the barrel part (diameter-decreased portion) 21.

As described above, when the barrel part 21 in the middle is decreased in diameter, it is possible to satisfy an internal superficial velocity necessary for conveyance of the biomass powder 17 even if the flow volume of the carrier gas 18 is set with A/C ratio of about 2 to 4.

When the plurality of discharge tubes 22 is provided on a line extended from the narrowed barrel part 21 in the vertical direction, the biomass powder 17 conveyed by the carrier gas 18 can be directly discharged while maintaining the flow velocity of the carrier gas 18.

Specifically, the carrier gas 18 can convey the biomass powder (fine powder) 17 without any obstacle while maintaining the raised superficial velocity.

In this arrangement, the relationship between a diameter d of the narrowed portion of the barrel part 21 and a diameter D of the mill table 14 preferably meets d≦D×0.8. This is because a desired flow velocity could not be achieved with d>D×0.8.

In the present invention, the milled powder can be classified only by a gravity classifying function of the mill in the height direction without having to provide a conventional mechanical classifier (for example, a rotary classifier or the like), which allows a device configuration to be simplified.

Height adjustment by gravitational classification varies depending on the size of the device. It is thus preferred to decide the relationship between the mill table 14 and the barrel part 21, decide the A/C ratio in the carrier gas 18, and then determine an optimum height for gravitational classification.

As described above, in the embodiment, when the barrel part 21 in the middle is reduced in diameter, it is possible to satisfy the internal superficial velocity necessary for conveyance of the biomass powder 17 even if the flow volume of carrier gas is decreased with A/C ratio of about 2 to 5.

The internal superficial velocity V preferably meets the relationship 0.5≦V≦2.0 (m/s). This is because, at a velocity of less than 0.5 m/s, the material is undesirably over-milled with too small amount of air, whereas at a velocity of more than 2.0 m/s, the milled material includes undesirably a large number of coarse particles, thereby decreasing combustion efficiency.

In the present invention, the barrel part (diameter-decreased part) 21 has the narrowed portion to maintain the superficial velocity of air flow until reaching the discharge tubes 22. The barrel part 21 is increased in diameter above the narrowed portion. The amount of diameter increase and the length from the barrel part 21 to the top plate 13a are adjusted to allow appropriate gravitational classification.

The relationship among an air amount Q, the cross section area of the barrel part 21 (excluding the area of the material feed pipe 12), and the superficial velocity V, can be expressed as in the following equation (1):

Air amount(Q:m²/s)=cross section area(S:m²)×superficial velocity(V:m/s) (1)

Accordingly, when the A/C ratio is decreased to about 2 to 5, direct combustion at boiler equipment can be realized, eliminating a conventional bin system such as a bug filter or a cyclone for separating excessive air, for example. This makes it possible to provide a simplified boiler combustion system, thereby to realize cost reduction and avoid trouble (for example, clogging, firing, or the like) possibly occurring in a bin system.

### Second Embodiment

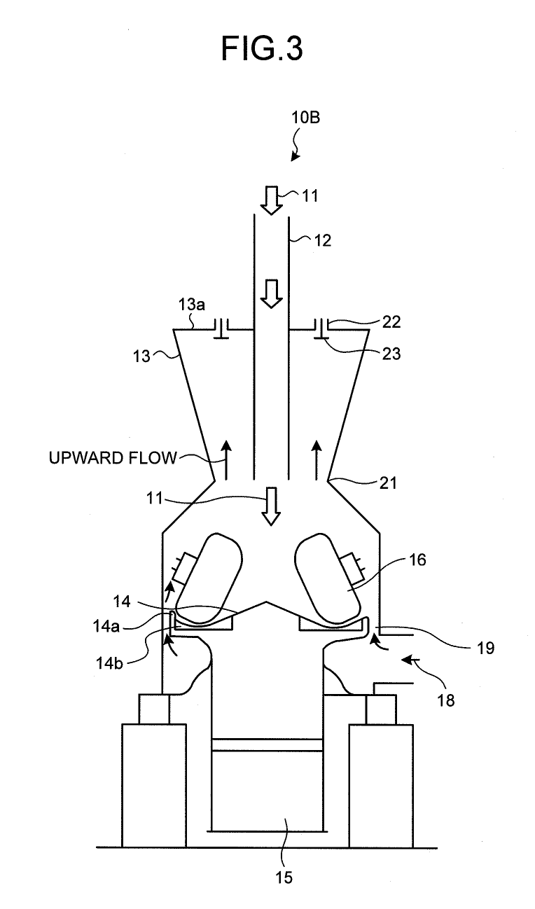

A biomass mill according to a second embodiment in the present invention will be described with reference to the drawings. FIG. 3 is a schematic view of a biomass mill according to the embodiment. The same configurations and members of the biomass mill in the first embodiment as those in the biomass mill in the embodiment are given the same reference numerals as those in the first embodiment, and descriptions thereof are omitted here.

As illustrated in FIG. 3, a biomass mill 10B according to the embodiment is configured such that collision plates 23 are provided near openings of the discharge tubes 22 in the biomass mill 10A.

In this arrangement, it is preferred to set the diameter of the collision plates 23 to 0.8 times or less the diameter of the openings of the discharge pipes 22. It is also preferred to set the height of the collision plates 23 along the vertical axis so as to be capable of being changed by a raising and lowering means not illustrated.

Large-size particles in biomass powder are not burned at boiler combustion, and thus the state of boiler combustion is monitored. If there exists a large number of unburned particles, the collision plates 23 are raised toward the openings to narrow the entrances and prevent discharge of large particles in the biomass powder 17.

In the embodiment, the collision plates 23 are suspended by a suspension means through the insides of the discharge pipes 22. However, the present invention is not limited to this but the collision plates 23 may be suspended by the suspension means on the peripheries of the discharge pipes 22. In addition, when the collision plates 23 are not to be changed in height, the collision plates 23 may be supported by a support member on the inner wall side of the mill main body 13.

### Third Embodiment

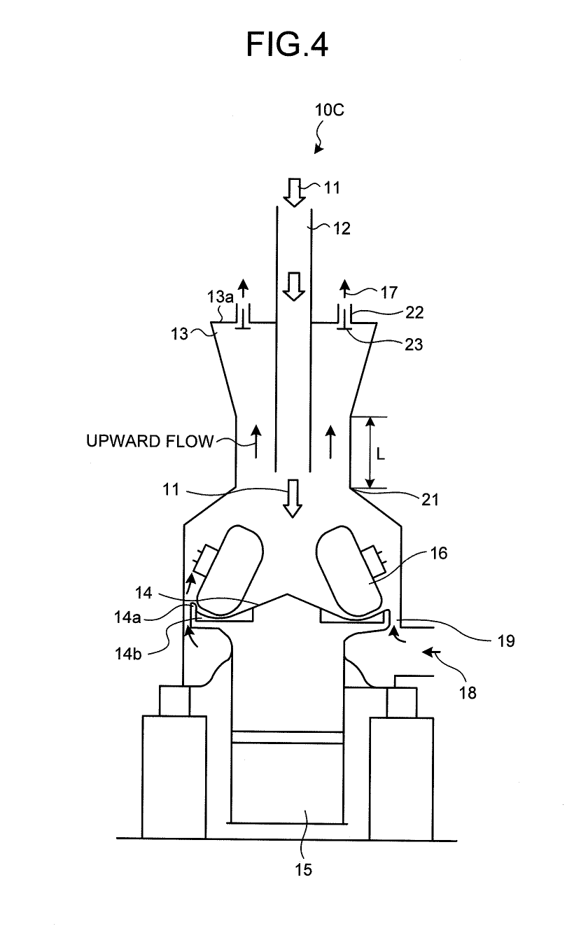

A biomass mill according to a third embodiment in the present invention will be described with reference to the drawings. FIG. 4 is a schematic view of a biomass mill according to the embodiment. The same configurations and members of the biomass mill in the third embodiment as those in the biomass mill in the first embodiment are given the same reference numerals as those in the first embodiment, and descriptions thereof are omitted here.

As illustrated in FIG. 4, a biomass mill 10C according to the embodiment is formed such that the diameter-decreased barrel part 21 in the biomass mill 10B according to the second embodiment is extended by a predetermined length L in the vertical axis direction.

This makes it possible to maintain reliably a desired flow velocity varying at diameter decrease in the height direction.

### Fourth Embodiment

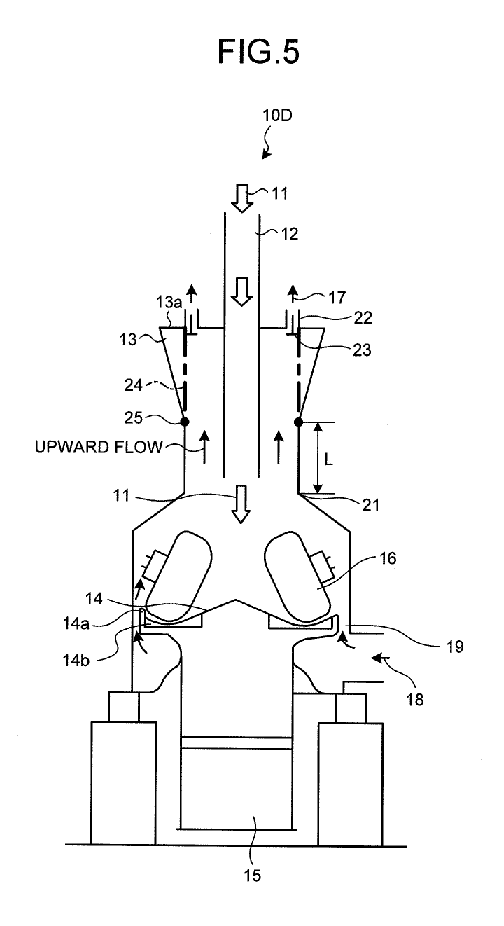

A biomass mill according to a fourth embodiment in the present invention will be described with reference to the drawings. FIG. 5 is a schematic view of a biomass mill according to the embodiment. The same configurations and members of the biomass mill in the fourth embodiment as those in the biomass mill in the first embodiment are given the same reference numerals as those in the first embodiment, and descriptions thereof are omitted here.

As illustrated in FIG. 5, a biomass mill 10D according to the embodiment is formed such that the biomass mill 100 according to the third embodiment is provided with a movable wall 24 to change freely the diameter of the barrel part of the mill main body on the top plate 13a side. The movable wall 24 is movable by a hinge 25 or the like, for example, and is generally integrated with the inner wall.

As described in the foregoing, the diameter of the barrel part (diameter-decreased part) 21 is variable at the upper portion, it is possible to change arbitrarily the superficial velocity for gravitational classification and control the particle size of the product discharged from the discharge pipes 22.

In addition, the biomass mill 10D may be configured to allow a member to be inserted to increase the opening area of the gap 19 on the outer periphery of the mill table 14, thereby to change the flow velocity of the upward carrier gas 18.

Since biomass greatly varies in specific gravity depending on the kind (softwood, hardwood, or pellet), the necessary internal superficial velocity varies depending on the kind of biomass even with a constant A/C ratio. However, when the movable wall 24 and the gap 19 are adjusted in opening area even with a constant amount of air, it is possible to adjust the internal superficial velocity and control the particle size of the product in a preferable manner.

### Fifth Embodiment

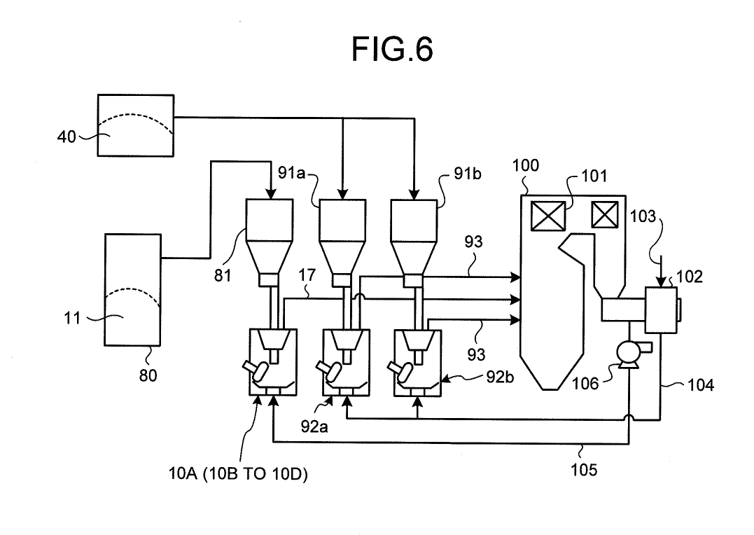

A biomass-coal mixed combustion system with a boiler furnace according to a fifth embodiment in the present invention will be described with reference to the drawings. FIG. 6 is a schematic view of a biomass-coal mixed combustion system with a boiler furnace according to the embodiment.

As illustrated in FIG. 6, the foregoing biomass mill 10A (10B to 10D) is applied to the biomass-coal mixed combustion system with a boiler furnace according to the Embodiment.

As illustrated in FIG. 6, the biomass-coal mixed combustion system with a boiler furnace according to the Embodiment includes: biomass reservoir equipment 95 storing the biomass material 11 as a dried biomass solid; a biomass mill 10A (10B to 10D) with a biomass hopper 96 into which the biomass material 11 is supplied; coal mills 92a and 92b including hoppers 91a and 91b receiving coal 90; and a boiler furnace 100 to which the biomass powder 17 obtained by the biomass mill 10A (10B to 10D) and coal powder 93 obtained by the coal mills 92a and 92b are supplied.

The biomass material 11 such as wood waste is evenly sized to a certain degree and stored as biomass chips, and then supplied to the biomass hopper 96. The biomass chips are supplied from the biomass hopper 96 to the biomass mill 10A (10B to 10D) and then milled by the mill table 14 and the mill roller 16. The milled biomass and coal are supplied to the boiler furnace 100, and the biomass powder 17 and the coal powder 93 are mixed and combusted in the boiler furnace 100.

The boiler furnace 100 has in the furnace main body a fuel supply nozzle and a burner co-operating with the fuel supply nozzle. A flue gas generated by combustion is transferred to a flue gas duct while heating a heat-transfer tube 101 provided in the furnace. An air heater (AH) 102 is disposed in the middle of the flue gas duct provided at the outlet of the furnace main body, and the flue gas having passed through the air heater 102 is released to the atmosphere through flue gas processing equipment (not illustrated) such as an ash precipitator.

High-temperature air 104 generated by heating outdoor air 103 at the air heater 102 is supplied to the coal mills 92a and 92b and used for dehydration of coal. In addition, part of flue gas 105 is supplied to the biomass mill 10A (10B to 10D) by an induction fan 106 and is used for classification and dehydration of biomass.

In the system including the biomass mill according to the present invention, biomass milling can be favorably performed, and thus even when the milled product is to be directly put to a combustion device for combustion, it is possible to achieve stable combustion without decreasing the combustion device in combustion performance.

In addition, since the entire amount of a press gas does not change from the conventional one, it is possible to operate the biomass mill stably without variations in the primary air within the range of air volume needed at combustion equipment.

### Sixth Embodiment

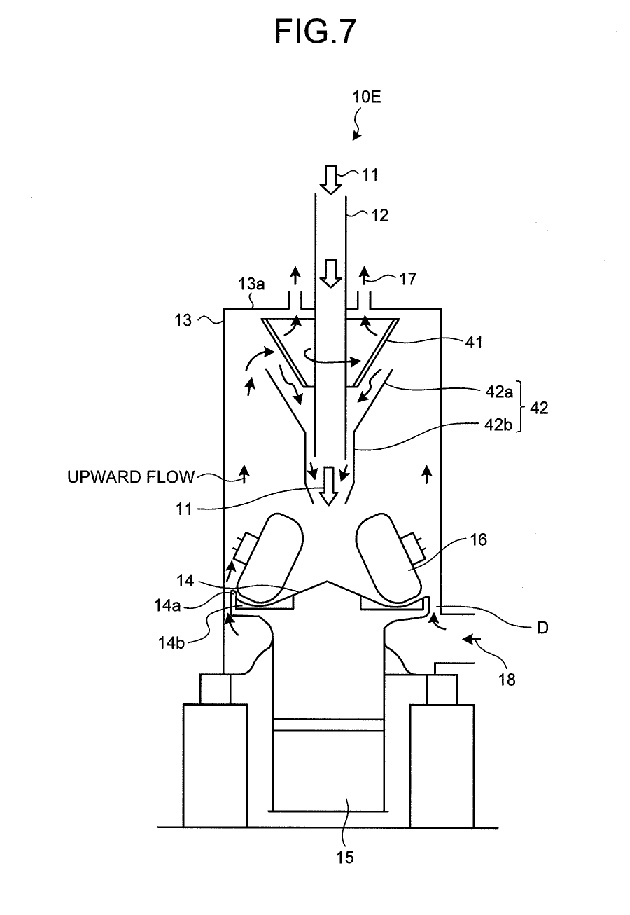

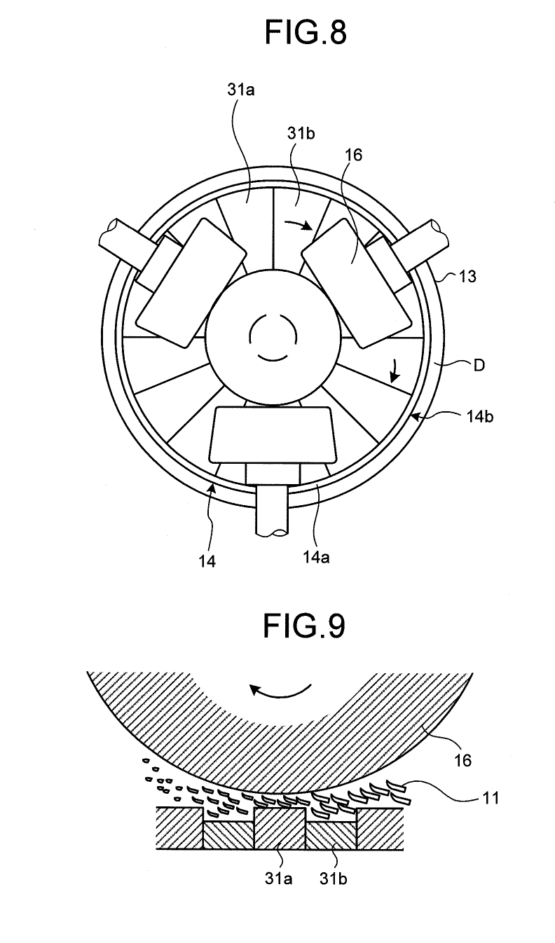

A biomass mill according to a sixth embodiment in the present invention will be described with reference to the drawings. FIG. 7 is a schematic view of a biomass mill according to the embodiment. FIG. 8 is a schematic cross section view of the biomass mill according to the sixth embodiment.

As illustrated in FIGS. 7 and 8, a biomass mill 10E according to the embodiment includes: the mill main body 13 having the material feed pipe 12 for feeding the biomass material 11 from above in the vertical axis direction; the mill table 14 on which the fed biomass material 11 is placed; the drive unit 15 rotating and driving the mill table 14; the mill roller 16 that operates in conjunction with rotation of the mill table 14 to mill the biomass material 11 by a pressing force; and a ventilation means (not illustrated) that forms an upward flow from below on the outer peripheral side of the mill table 14 to blow out the carrier gas 18 to convey milled biomass powder 17 by a flow of air, wherein the table liner 14b of the mill table 14 is divided into a plurality of fan-like segments 31a and 31b, and the fan-like segments 31a and 31b are different in thickness in the height direction.

The mill table 14 is formed into an almost circular stand. The mill table 14 has an upper surface that is concaved to prevent the biomass solid placed on the table from dropping out and is provided with the barrier 14a on the outer peripheral side thereof. In addition, the mill table 14 has the replaceable table liner 14b to prevent abrasion of the mill table 14.

The mill table 14 has a drive shaft (not illustrated) extended from under the table and connected to a motor (not illustrated) such that the mill table 14 is rotated and driven by the motor.

The mill roller 16 is provided above the mill table 14 at a position shifted outward from the center of the mill table 14. The mill roller 16 rotates in conjunction with rotation of the mill table 14 and exerts a pressing force on the biomass material 11 placed on the table liner 14b of the mill table 14 to mill the biomass material 11.

In this arrangement, the motor is connected to a decelerator, and the mill roller 16 is connected to a variable oil pressure source or a spring for changing a milling load. The motor and the mill roller 16 are configured to be capable of being controlled by a control device (not illustrated) to increase and decrease a milling load of the mill roller 16 in a step-less or stepwise manner to keep a milling power within a rated range or preferably in an almost constant state.

The material feed pipe 12 is provided to pass through the top plate 13a of the mill main body 13 and fall the biomass material 11 onto the mill table 14.

A classifier 41 is configured to subject slightly fine powder having undergone wind classification (primary classification) by the carrier gas (primary air) 18 to secondary classification. The classifier 41 is a fixed classifier (cyclone separator) or a rotary classifier (rotary separator) or the like.

The classifier 41 of the embodiment is a funnel-like classifier that is configured to classify milled product into coarse particles and fine particles by a classifying blade provided at an opening not illustrated. The classified coarse particles are fallen onto the mill table 14 for re-milling.

The ventilation means for supplying the carrier gas (primary air) 18 is configured to supply a predetermined flow volume of the primary air at a predetermined temperature into the mill main body 13 from the periphery of the mill table 14. The ventilation means uses a damper or the like to adjust a flow volume of air. In addition, the ventilation means includes a temperature adjustment means as necessary. The flow volume and the temperature of air are appropriately controlled by a control device not illustrated.

A gap D is provided between the outer peripheral edge of the mill table 14 and the inner peripheral surface of the mill main body 13 such that the carrier gas (primary air) 18 supplied from the ventilation means blows through the gap D above the mill table 14. The gap D may be provided with a drift vane (not illustrated). The drift vane is intended to adjust the direction of blowing of the primary air, and more preferably, the drift vane may be arbitrarily controlled in angle.

A funnel-like rectifier member 42 is almost the same in shape as the classifier 41, and is fixed above the mill main body 13 with predetermined spacing from the classifier 41 and is extended downward. The funnel-like rectifier member 42 is configured to drop again the biomass powder (coarse particles) classified by the classifier 41 onto the mill table 14. The funnel-like rectifier member 42 includes a funnel portion 42a that is narrowed and widened from upper to lower parts to receive the classified biomass powder (coarse particles) and a trunk portion 42b that is placed with predetermined spacing from the material feed pipe 12 to drop the biomass powder (coarse particles).

The trunk portion 42b of the funnel-like rectifier member 42 is decreased in diameter at a lower end portion to prevent dispersion of the classified and dropped biomass powder (coarse particles).

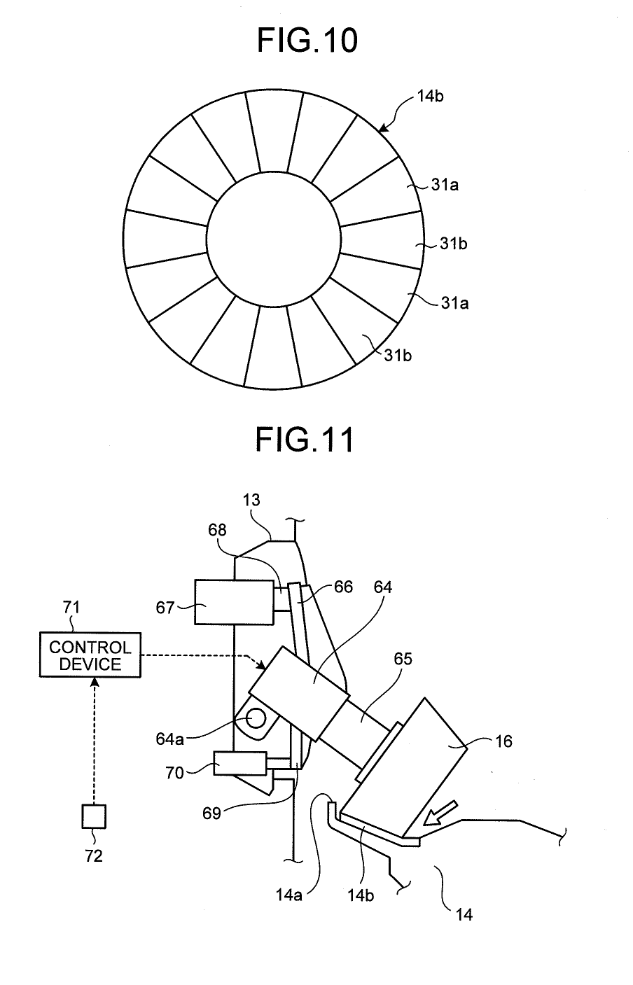

FIG. 9 is a schematic view of the table liner and the mill roller according to the sixth embodiment. FIG. 10 is a plane view of the table liner.

In the embodiment, as illustrated in FIG. 10, the table liner 14b as a milling plane is formed by the divided fan-like segments 31a and 31b. The segments 31a and 31b are made different in height and alternately arranged to form a stepped surface in the circumferential direction. Accordingly, as illustrated in FIG. 9, the table liner 14b can operate to cut the fibers of the biomass material 11 at angular portions of the convex segments 31a. As a result, it is possible to improve the efficiency of milling a biomass material, and thus provide a mill machine with high milling efficiency.

The number of divisions of the mill table 14b is two or more, preferably about 30. The number of the divisions may be changed as appropriate according to the size of the mill table 14b and the kind of biomass to be milled.

In the embodiment, the divisions of the mill table 14b are different in height in two ways. However, the present invention is not limited to this but the divisions of the mill table 14b may be different in height in three or more ways.

In addition, the fan-like segments may have different shapes, but preferably have an identical shape to facilitate replacement of the segments.

When the biomass mill in the sixth embodiment is applied to the foregoing biomass-coal mixed combustion system with a boiler furnace illustrated in FIG. 6, biomass milling can be favorably performed. Accordingly, even when the milled product is to be directly put to a combustion device for combustion, it is possible to achieve stable combustion without decreasing the combustion device in combustion performance.

### Seventh Embodiment

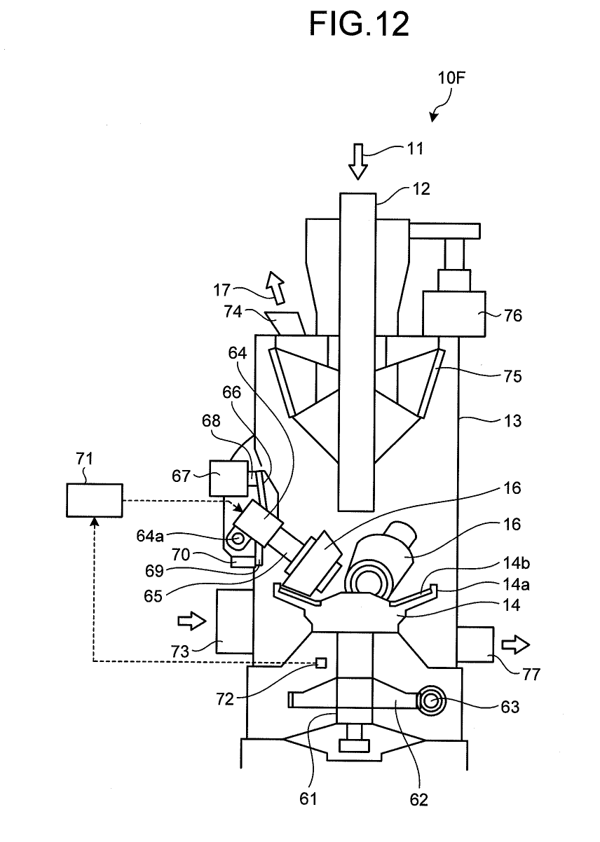

FIG. 11 is a front view of a mill roller and a drive unit for the mill roller in a vertical mill as a biomass mill according to a seventh embodiment in the present invention, and FIG. 12 is a schematic configuration diagram of the vertical mill as the biomass mill according to the seventh embodiment.

The vertical mill as a biomass mill according to the seventh embodiment is configured to mill a solid matter such as biomass. The biomass here refers to recyclable, biological organic resources. The biomass includes forest thinnings, wood scrap, driftwood, plants, wastes, sludge, tires, and recycle fuels (pellets and chips) made from the foregoing matters as raw materials, and others, for example, but the biomass is not limited to the foregoing ones. The vertical mill in the example is not limited to an application for milling biomass solids but may be configured to mill coal or mixture of coal and biomass solids.

In a biomass mill 10F according to the embodiment, as illustrated in FIGS. 11 and 12, the mill main body (housing) 13 has a void circular cylindrical shape and, the material feed pipe 12 feeding biomass is attached to the upper part of the mill main body 13. The material feed pipe 12 is configured to feed the biomass material 11 as a biomass solid from a biomass feed device not illustrated into the mill main body 13. The material feed pipe 12 is arranged in the up-down direction (vertical direction) at the center of the mill main body 13 and has a lower end portion extended downward.

The mill main body 13 has the mill table 14 at a lower part thereof. The mill table 14 is located at the center of the mill main body 13 so as to be opposed to the lower end portion of the material feed pipe 12. In addition, the mill table 14 is connected at a lower part thereof to a rotation shaft 61 with a rotation axis center along the vertical direction, and thus the mill table 14 is rotatably supported at the mill main body 13. The rotation shaft 61 is fixed to a worm wheel 62 as a drive gear, and a worm gear 63 in a drive motor (not illustrated) mounted in the mill main body 13 engages with the worm wheel 62. Therefore, the mill table 14 is capable of being driven and rotated by the drive motor via the worm gear 63, the worm wheel 62, and the rotation shaft 61.

The mill table 14 also has the ring-shaped table liner 14b fixed to the outer peripheral side thereof. The table liner 14b forms an inclined plane in which a surface (upper surface) becomes higher with increasing proximity to the outer peripheral side of the mill table 14. In addition, a plurality of mill rollers 16 is arranged above the mill table 14 (the table liner 14b) so as to be opposed to the mill table 14 (the table liner 14b), and a roller drive device 64 is provided to drive and rotate the mill rollers 16. The roller drive device 64 may be a motor, for example, to apply a driving force to the mill rollers 16.

Specifically, a support shaft 65 is supported at a back end portion by the roller drive device 64, and the roller drive device 64 is supported by an attachment shaft 64a at a side wall portion of the mill main body 13, whereby a leading end portion of the support shaft 65 is swingable in the up-down direction. The support shaft 65 has the leading end portion oriented in the direction of the rotation axis center of the mill table 14 and inclined downward. The mill roller 16 is attached to the support shaft 65.

In addition, the roller drive device 64 (the support shaft 65) is provided with an upper arm 66 extending upward. A leading end portion of the upper arm 66 is connected to a leading end portion of a press rod 68 of an oil pressure cylinder 67 as a press device fixed to the mill main body 13. The roller drive device 64 (the support shaft 21) is provided with a lower arm 69 extending downward. The lower arm 69 has a leading end portion capable of abutting a stopper 70 fixed to the mill main body 13. Therefore, when the press rod 68 is moved ahead by the oil pressure cylinder 67, it is possible to press the upper arm 66 and rotate the roller drive device 64 and the support shaft 65 clockwise in FIG. 11 with the attachment shaft 64a as a support point. At that time, the upper arm 66 abuts the stopper 70 to define the rotational position of the roller drive device 64 and the support shaft 65.

Specifically, the mill roller 16 is configured to mill a biomass solid between the mill roller 16 and the mill table 14 (the table liner 14b), and it is thus necessary to provide a predetermined gap between the surface of the mill roller 16 and the surface of the mill table 14 (the table liner 14b). When the support shaft 65 is defined at the predetermined rotational position by the oil pressure cylinder 67, it is possible to provide a predetermined gap in which a biomass solid can be taken and milled between the surface of the mill roller 16 and the surface of the mill table 14.

In this case, when the mill table 14 rotates, the biomass solid fed onto the mill table 14 is moved to the outer peripheral side of the mill table 14 by a centrifugal force and entered between the mill roller 16 and the mill table 14. Since the mill roller 16 is pressed against the mill table 14, the rotating force of the mill table 14 is transferred via the biomass solid, and thus the mill roller 16 can rotate in conjunction with the rotation of the mill table 14.

In the embodiment, the mill roller 16 is formed in a conical trapezoidal shape with a diameter decreased at the leading end portion side thereof, and the mill roller 16 is configured to have a flat surface. However, the mill roller 16 is not limited to this form. For example, the mill roller 16 may have the form of a tire. In the embodiment, a plurality of (three) mill rollers 16 is arranged at equal intervals along the rotation direction of the mill table 14. In this case, the number and layout of the mill rollers 16 may be set as appropriate depending on the sizes or the like of the mill table 14, the mill roller 16, and the like.

In the seventh embodiment, a control device 71 controlling the roller drive device 64 is provided as a roller speed adjustment mechanism that is capable of adjusting the rotation speed of the mill rollers 16 such that the peripheral speed of the mill rollers 16 is different from the peripheral speed of the mill table 14. Further, a detector 72 is provided to detect the rotation speed of the mill table 14 and output detection results to the control device 71. The control device 71 adjusts the rotation speed of the mill rollers 16 by the roller drive device 64 according to the rotation speed of the mill table 14.

Specifically, the control device 71 determines the peripheral speed of the mill table 14 at a position opposed to the mill rollers 16 according to the rotation speed of the mill table 14 detected by the detector 72, and the control device 71 drives and controls the roller drive device 64 to set the rotation speed of the mill rollers 16 such that the peripheral speed of the mill rollers 16 is different from the peripheral speed of the mill table 14.

In this case, the control device 71 desirably sets the rotation speed of the mill rollers 16 by the roller drive device 64 such that the peripheral speed of the mill rollers 16 is slightly higher than the peripheral speed of the mill table 14.

The mill main body 13 has at the lower portion thereof an inlet port 73 into which the primary air is fed, which is located around the outer periphery of the mill table 14. In addition, the mill main body 13 has at the upper portion thereof an outlet port 74 for discharging milled biomass, which is located around the outer periphery of the material feed pipe 12. The mill main body 13 has under the outlet port 74 a rotary separator 75 as a classifier for classifying milled biomass. The rotary separator 75 is provided at the outer peripheral portion of the material feed pipe 12 and is capable of being driven and rotated by a drive device 76. The mill main body 13 also has a foreign object discharge tube 77 at the lower portion thereof. The foreign object discharge tube 77 is configured to let foreign objects (spillage) such as gravel and metal pieces mixed in the biomass solid fall off from the outer peripheral portion of the mill table 14 and discharge the same.

When a solid matter such as the biomass material 11 is fed from the material feed pipe 12 into the mill main body 13 by the thus configured vertical mill in the seventh embodiment, the solid matter falls through the material feed pipe 12 and is fed onto the central portion of the mill table 14. At that time, since the mill table 14 rotates at a predetermined speed, the solid matter fed onto the central portion of the mill table 14 is moved and dispersed in four directions by the action of a centrifugal force, and thus a constant layer is formed on the entire surface of the mill table 14. That is, the solid matter such as biomass enters between the mill roller 16 and the mill table 14.

Accordingly, the rotation force of the mill table 14 is transferred to the mill rollers 16 via the solid matter such as biomass, and thus the mill rollers 16 rotate in conjunction with rotation of the mill table 14. At that time, since the mill rollers 16 are pressed and supported by the oil pressure cylinder 67 at the mill table 14 side, the mill rollers 16 press and mill the solid matter while rotating.

At that time, the control device 71 drives and controls the roller drive device 64 according to the rotation speed of the mill table 14 detected by the detector 72, thereby to set the rotation speed of the mill rollers 16. Specifically, the control device 71 adjusts the rotation speed of the mill rollers 16 such that the peripheral speed of the mill rollers 16 is slightly higher than the peripheral speed of the mill table 14. This makes a difference in speed between the mill roller 16 and the mill table 14 to exert a shearing force on the solid matter. Accordingly, the mill rollers 16 can press and cut the solid matter and mill the same with efficiency while rotating.

The solid matter milled by the mill roller 16 is dried and raised by the primary air fed from the input port 73 into the mill main body 13. The raised milled solid matter is classified by the rotary separator 75, and the coarse particles are fallen and returned again onto the mill table 14 for re-milling. Meanwhile, the fine powder passes through the rotary separator 75, and is carried by a flow of air and discharged from the outlet port 74. In addition, the spillage such as gravel and metal pieces mixed in the solid matter such as biomass falls outward from the outer peripheral portion of the mill table 14 by the centrifugal force of the mill table 14, and then is discharged from the discharge tube 77.

In the foregoing vertical mill in the seventh embodiment, the mill table 14 is supported with a rotation axis center along the vertical direction in the mill main body 13 so as to be capable of being driven and rotated, the mill rollers 16 are arranged above the mill table 14 so as to be opposed to the mill table 14 and capable of rotating in conjunction with rotation of the mill table 14, the mill rollers 16 are capable of being driven and rotated by the roller drive device 64, and the control device 71 can control the roller drive device 64 to adjust the rotation speed of the mill roller 16 such that the peripheral speed of the mill roller 16 is different from the peripheral speed of the mill table 14.

Therefore, when the mill table 14 is driven and rotated and a solid matter such as biomass is fed onto the mill table 14, the solid matter moves outward by the centrifugal force and enters between the mill table 14 and the mill roller 16. Then, when the mill rollers 16 rotate by rotation of the mill table 14 to mill the solid matter, and at that time, when the rotation speed of the mill roller 16 is adjusted by the control device 71, a shearing force acts on the solid matter to facilitate milling, and thus the solid matter such as biomass can be milled with efficiency, thereby improving milling efficiency.

In this case, as a roller speed adjustment mechanism, when the roller drive device 64 is used to apply a drive force to the mill rollers 16, the roller drive device 64 applies the drive force to the mill rollers 16, and thus the peripheral speed of the mill roller 16 becomes different from the peripheral speed of the mill table 14, which exerts a shearing force on the solid matter with improvement in milling efficiency.

In addition, the control device 71 adjusts the rotation speed of the mill rollers 16 by the roller drive device 64 such that the peripheral speed of the mill rollers 16 is higher than the peripheral speed of the mill table 14. This makes the solid matter prone to enter between the mill rollers 16 and the mill table 14 and improves the efficiency of milling the solid matter.

In the seventh embodiment, the control device 71 adjusts the rotation speed of the mill rollers 16 by the roller drive device 64 such that the peripheral speed of the mill rollers 16 is higher than the peripheral speed of the mill table 14. Alternatively, the control device 71 may adjust the rotation speed of the mill rollers 16 by the roller drive device 64 such that the peripheral speed of the mill rollers 16 is slightly lower than the peripheral speed of the mill table 14. In addition, the control device 71 may adjust the rotation direction of the mill rollers 16 by the roller drive device 64 such that the rotation direction of the mill rollers 16 is opposite to the rotation direction of the mill table 14. Further, since the mill rollers 16 rotate at almost the same speed as that of the mill table 14 to which the rotation force of the mill table 14 is transferred via the solid matter, a roller brake device may be used as a roller speed adjustment mechanism to apply a brake force to the mill rollers 16, and adjust the rotation speed of the mill rollers 16 such that the peripheral speed of the mill rollers 16 is different from the peripheral speed of the mill table 14, that is, the peripheral speed of the mill rollers 16 is lower than the peripheral speed of the mill table 14.

### Eighth Embodiment

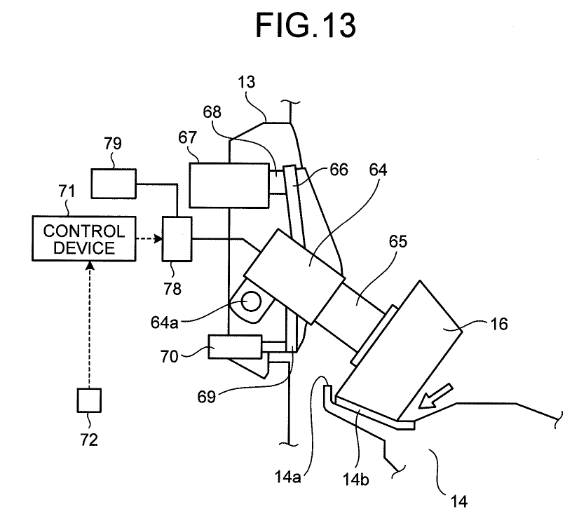

FIG. 13 is a front view of a mill roller and a drive unit for the mill roller in a vertical mill as a biomass mill according to an eighth embodiment of the present invention. The same configurations and members of the biomass mill in the eighth embodiment as those in the biomass mills in the foregoing embodiments are given the same reference numerals as those in the foregoing embodiments, and descriptions thereof are omitted here.

In the vertical mill in the eighth embodiment, as illustrated in FIG. 13, a plurality of mill rollers 16 is disposed above the mill table 14 (the table liner 14b) so as to be opposed to the mill table 14, and the mill rollers 16 are capable of being driven and rotated by the roller drive device 64. The roller drive device 64 is a motor generator and may function as both an electric motor and a generator.

Specifically, the roller drive device (motor generator) 64 is connected to an inverter 78, and the inverter 78 is connected to a storage battery 79, and the control device 71 can control the inverter 78. The motor generator constituting the roller drive device 64 has the function of converting electric power supplied from the storage battery 79 to mechanical power and outputting the same to the support shaft 65, and the function of converting mechanical power input into the support shaft 65 to electric power and collecting the same.

That is, when the roller drive device (motor generator) 64 functions as a motor, the roller drive device 64 can rotate the mill rollers 16 via the support shaft 65. In this case, the control device 71 controls the roller drive device 64 by the inverter 78 such that the peripheral speed of the mill rollers 16 is slightly higher than the peripheral speed of the mill table 14. Meanwhile, when the roller drive device (motor generator) 64 functions as a generator, the rotation force of the mill table 14 is transferred to the mill rollers 16 via the solid matter to rotate the support shaft 65, the roller drive device 64 can convert the rotation force of the support shaft 65 to electric power and store the same in a storage battery 82. In this case, the control device 71 functions as an electric power regeneration brake to control the roller drive device 64 by an inverter 81 such that the peripheral speed of the mill roller 16 is slightly lower than the peripheral speed of the mill table 14.

The operations of the vertical mill in the embodiment are the same as those in the seventh embodiment, and thus detailed descriptions thereof are omitted.

As described above, in the vertical mill in the eighth embodiment, the roller drive device 64 is set as a motor generator, the mill rollers 16 are capable of being driven and rotated by the roller drive device 64, and the rotation speed of the mill rollers 16 can be adjusted by the control device 71 such that the peripheral speed of the mill rollers 16 is different from the peripheral speed of the mill table 14. Therefore, when the control device 71 adjusts the rotation speed of the mill rollers 16 such that the peripheral speed of the mill rollers 16 is different from the peripheral speed of the mill table 14, the mill rollers 16 exert a shearing force on the solid matter to facilitate milling, which makes it possible to mill the solid matter such as biomass with efficiency, thereby improving milling efficiency.

In this case, when the roller drive device 64 is set as a motor generator, the peripheral speed of the mill rollers 16 can be easily made different from the peripheral speed of the mill table 14. In addition, since the roller drive device (motor generator) 64 is capable of regenerative braking, applying regenerative brake to the mill rollers 16 makes it possible to convert heat energy to electric energy and collect the same, thereby achieving effective use of the collected electric power.

The configurations of the biomass mills in the seventh and eighth embodiments may be applied to the biomass mill in any of the first to sixth embodiments.

In addition, applying the biomass mills in the seventh and eighth embodiments to the biomass-coal mixed combustion system with a boiler furnace illustrated in FIG. 6, makes it possible to realize favorable biomass milling. Accordingly, even when the milled matter is to be directly put into a combustion device, stable combustion can be achieved without decreasing combustion performance.

### REFERENCE SIGNS LIST

10A to 10D Biomass mill
11 Biomass material
12 Material feed pipe
13 Mill main body
14 Mill table
15 Drive unit
16 Mill roller
17 Biomass powder
18 Carrier gas
21 Barrel part (diameter-decreased part)
22 Discharge tube
23 Collision plate
31a and 31b Fan-like segment
41 Classifier
42 Funnel-like rectifier member
64 Roller drive device (roller speed adjustment mechanism)
65 Support shaft
67 Oil pressure cylinder (press device)
71 Control device (roller speed adjustment mechanism)
72 Detector
78 Inverter
79 Storage battery

1. A biomass mill comprising:
a mill main body including a material feed pipe for feeding a biomass material from above in a vertical axis direction;
a mill table for placing the fed biomass material;
a drive unit for rotating and driving the mill table;
a mill roller for operating in conjunction with rotation of the mill table so as to mill the biomass material by a pressing force; and
a ventilation means for forming an upward flow from below on the outer peripheral side of the mill table and blowing out a carrier gas so as to convey milled biomass powder by a flow of air, wherein
the mill main body has a barrel part decreased in diameter in the middle thereof in the vertical axis direction, and
the mill main body has on a top part thereof a plurality of discharge tubes circumferentially arranged for discharging the biomass powder on a line extended from the diameter-decreased barrel part in the vertical axis direction.

2. The biomass mill according to claim 1, wherein
collision plates are provided near openings of the discharge tubes.

3. The biomass mill according to claim 1, wherein
the diameter-decreased barrel part is extended by a predetermined length in the vertical axis direction.

4. The biomass mill according to claim 1, wherein
the barrel part of the mill main body is variable on the top part side.

5. A biomass mill, comprising:
a mill main body having a material feed pipe for feeding a biomass material from above in a vertical axis direction;
a mill table having a table liner for placing the fed biomass material;
a drive unit for rotating and driving the mill table;
a mill roller for operating in conjunction with rotation of the mill table so as to mill the biomass material by a pressing force;
a ventilation means for forming an upward flow from below on the outer peripheral side of the mill table and blowing out a carrier gas so as to convey milled biomass powder by a flow of air; and
a classifier provided on the top part side of the mill main body, for classifying biomass fine particles entrained in the carrier gas, wherein
the table liner of the mill table is divided into a plurality of fan-like segments, and
the fan-like segments are different in thickness in the height direction.

6. The biomass mill according to claim 5, wherein
the fan-like segments have the identical shape.

7. A biomass mill, comprising:
a mill table rotatably supported in a mill main body, including a rotation axis center along a vertical direction of the mill main body;
a mill roller arranged above the mill table, the mill roller being opposed to the mill table and rotatably supported; and
a roller speed adjustment mechanism for adjusting a rotation speed of the mill roller such that the peripheral speed of the mill roller is different from the peripheral speed of the mill table.

8. The biomass mill according to claim 7, wherein
the roller speed adjustment mechanism includes a brake/drive device for applying a drive force or a brake force to the mill roller.

9. The biomass mill according to claim 7, wherein
the roller speed adjustment mechanism includes a drive device for applying a drive force to the mill roller, and
the drive device is configured to adjust the rotation speed of the mill roller such that the peripheral speed of the mill roller is higher than the peripheral speed of the mill table.

10. The biomass mill according to claim 7, wherein
the roller speed adjustment mechanism includes an electric motor for driving and rotating the mill roller.

11. The biomass mill according to claim 10, wherein
the electric motor is configured to regenerative-brake.

12. A biomass-coal mixed combustion system, comprising:
the biomass mill according to claim 1;
a coal mill for milling a coal material; and
a boiler furnace into which biomass powder milled by the biomass mill and coal powder milled by the coal mill are fed.

13. A biomass-coal mixed combustion system, comprising:
the biomass mill according to claim 5;
a coal mill for milling a coal material; and
a boiler furnace into which biomass powder milled by the biomass mill and coal powder milled by the coal mill are fed.

14. A biomass-coal mixed combustion system, comprising:
the biomass mill according to claim 7;
a coal mill for milling a coal material; and
a boiler furnace into which biomass powder milled by the biomass mill and coal powder milled by the coal mill are fed.
